(19) United States
(12) Patent Application Publication
(10) Pub. No.: US 2014/0281053 A1
(43) Pub. Date: Sep. 18, 2014

(54) I/O DEVICE CONTROL SYSTEM AND METHOD FOR CONTROLLING I/O DEVICE

(71) Applicant: NEC CORPORATION, Tokyo (JP)

(72) Inventors: Jun Suzuki, Tokyo (JP); Youichi Hidaka, Tokyo (JP); Junichi Higuchi, Tokyo (JP); Takashi Yoshikawa, Tokyo (JP); Teruyuki Baba, Tokyo (JP); Yoshikazu Watanabe, Tokyo (JP)

(21) Appl. No.: 14/353,838

(22) PCT Filed: Oct. 26, 2012
(86) PCT No.: PCT/JP2012/077795

§ 371 Date: Apr. 24, 2014

(30) Foreign Application Priority Data
Oct. 28, 2011 (JP) 2011-237593

(51) Int. Cl. G06F 13/28

(52) U.S. Cl. CPC G06F 13/28
USPC 710/22

(57) ABSTRACT

A plurality of bridge units which connect a computer, a data movement source I/O device, and a data movement destination I/O device to a network, a memory unit which relays movement of data between the data movement source I/O device and the data movement destination I/O device outside the computer, and an I/O data movement control unit which causes the data movement source I/O device to write data to the memory unit and causes the data movement destination I/O device to read the data from the memory unit are included.

### TECHNICAL FIELD

The present invention relates to an I/O (Input/Output) device control system and a method for controlling an I/O device, and more particularly, to an I/O device control system and a method for controlling an I/O device suitable for use when data is moved between I/O devices.

### BACKGROUND ART

In an I/O device control system described in Patent Literature 1, the system is configured by distributing and arranging a plurality of CPUs (Central Processing Units) and peripheral devices (i.e., I/O devices) in a network so that the peripheral devices are shared among the CPUs. Further, in the I/O device control system described in Patent Literature 1, the plurality of CPUs and the peripheral devices are connected by a PCI express (PCIe) switch through the network.

### DOCUMENT OF THE PRIOR ART

### Patent Document

[Patent Document 1]
Japanese Unexamined Patent Application, First Publication No. 2007-219873

### DISCLOSURE OF INVENTION

### Problems to be Solved by the Invention

In a PCIe interface described in Patent Literature 1, when data is moved between two I/O devices, the data is usually transmitted through a bus bridge or a memory connected to the CPU. Therefore, there is a problem in that the bus bridge or the memory becomes a bottleneck of a data movement band in the data movement between the two I/O devices.

Further, there is a problem in that applications which share the main memory or the bus bridge through which the data passes have a certain influence on an operation of the applications at the time of data movement between the I/O devices since all data moving between the I/O devices passes through the main memory or the bus bridge.

In other words, there is a problem in that, when the data is moved between two I/O devices connected by the PCIe interface, movement speed is limited or performance of applications operating in the CPU deteriorates.

An object of the present invention is to provide an I/O device control system and a method for controlling an I/O device which can solve the above-described problems.

### Means for Solving the Problem

In order to solve the above problems, an I/O device control system according to the present invention includes a plurality of bridge units which connect a data movement source I/O device from which data is moved, a data movement destination I/O device to which the data is moved, and a computer which controls the movement of the data to a network; a memory unit provided outside the computer which holds the data moving between the data movement source I/O device and the data movement destination I/O device; and an I/O data movement control unit provided inside the computer which instructs the data movement source I/O device to perform control of writing the data to the memory unit, and instructs the data movement destination I/O device to perform control of reading the data from the memory unit.

Further, a method for controlling an I/O device according to the present invention includes connecting a data movement source I/O device which is a data movement source, a data movement destination I/O device which is a data movement destination, and a computer which controls movement of the data via a network; and instructing the data movement source I/O device to perform control of writing the data to a memory unit provided outside the computer, and instructing the data movement destination I/O device to perform control of reading the data from the memory unit.

### Effects of the Invention

According to the present invention, since moving data can be directly transmitted using a network when the data is moved between I/O devices, it is possible to effectively perform the movement of the data between the I/O devices.

### BRIEF DESCRIPTION OF THE DRAWINGS

FIG. 1 is a block diagram illustrating a configuration of one embodiment of the present invention.

FIG. 2 is a diagram illustrating bridge information used in the embodiment illustrated in FIG. 1.

FIG. 3 is a diagram illustrating a parallel process management table used in the embodiment illustrated in FIG. 1.

FIG. 4 is a block diagram illustrating a memory space of a CPU used in the embodiment illustrated in FIG. 1.

FIG. 5 is a flowchart illustrating an operation of the embodiment illustrated in FIG. 1.

FIG. 6 is a flowchart illustrating an operation of the embodiment illustrated in FIG. 1.

FIG. 7 is a flowchart illustrating an operation of the embodiment illustrated in FIG. 1.

FIG. 8 is a diagram illustrating an example in which two parallel processes are set in the parallel process management table illustrated in FIG. 3.

FIG. 9 is a block diagram illustrating a configuration of another embodiment according to the present invention.

FIG. 10 is a block diagram illustrating a basic configuration of the embodiment of the present invention including each configuration example of the embodiment of the present invention described with reference to FIGS. 1 and 9.

### EMBODIMENTS FOR CARRYING OUT THE INVENTION

Hereinafter, embodiments of the present invention will be described with reference to the drawings. FIG. 1 is a block diagram illustrating a configuration of one embodiment of an I/O device control system according to the present invention. Referring to FIG. 1, the I/O device control system 10 of the embodiment of the present invention includes a computer 1, a network bridge A 2A, a network bridge a 2a, a network bridge b 2b, a network 3, an I/O device a 4a, and an I/O device b 4b.

The network 3 is a communication network including a wired or wireless LAN (Local Area Network), a WAN (Wide Area Network) or the like. The computer 1 is connected to the network 3 via the network bridge A 2A, the I/O device a 4a is connected to the network 3 via the network bridge a 2a, and the I/O device b 4b is connected to the network 3 via the network bridge b 2b.

The I/O device a 4a and the I/O device b 4b are input and output devices (i.e., peripheral devices or peripheral apparatuses) of the computer 1 which provides a network function or a storage function, and are, for example, devices having an interface conforming to PCIe or PCI (Peripheral Component Interconnect).

The I/O device a 4a and the I/O device b 4b are connected to the computer 1 via the network 3, and transmit or receive data or control information (hereinafter, the data and the control information are collectively referred to as data) to or from the computer 1 or between the I/O device a 4a and the I/O device b 4b.

Further, while the case in which the I/O device control system 10 includes both the I/O device a 4a and the I/O device b 4b is shown in FIG. 1, three or more I/O devices may be provided.

The computer 1 includes a CPU 14 which performs a calculation process, a main memory 16 which provides a storage unit, and a bus bridge 15 which connects the CPU 14, the main memory 16, and the network bridge A 2A to one another. Further, the computer 1 may include an input device, an output device, a peripheral device, and the like which are not illustrated.

The main memory 16 stores bridge information 161, a computer program 162, and a parallel process management table 163. The bridge information 161 includes information for the network bridge, such as the network bridge A 2A, the network bridge a 2a, or the network bridge b 2b. The computer program 162 includes a plurality of types of software programs executed by the CPU 14. In this embodiment, the computer program 162 includes an I/O data movement control program 1621, an optimal bridge search program 1622, an I/O device driver program a 1623a, and an I/O device driver program b 1623b.

Further, the computer program 162 includes an application program, which is not illustrated, that controls input, output and the like of data by the I/O device a 4a, the I/O device b 4b and the like. This application program identifies moving data and acquires information indicating a data capacity of the data when executed. Further, if this application program is executed, when movement of data up to a data capacity of the moving data is completed, it is determined that movement of an amount of data scheduled to be moved has been completed

The parallel process management table 163 is, for example, a data table used to manage the progress of the process when a process of moving a plurality of sets of data is executed in parallel between the I/O device a 4a and the I/O device b 4b. In other words, the parallel process management table 163 is used to manage a progress situation of the processes when data is moved as a plurality of sets of processes executed in parallel between a plurality of I/O devices, such as the I/O device a 4a and the I/O device b 4b.

Further, the main memory 16 may include a volatile memory, may include a nonvolatile memory, or may be a combination of the volatile memory and the nonvolatile memory. However, when the computer 1 stops, the bridge information 161, the computer program 162, and the parallel process management table 163 stored in the main memory 16 are assumed to be stored in the nonvolatile memory constituting the main memory 16 or a nonvolatile memory, which is not illustrated, provided outside the main memory 16.

The CPU 14 performs a predetermined calculation process or controls each unit in the computer 1 by executing a plurality of types of software programs included in the computer program 162 stored in the main memory 16. In this embodiment, particularly, the CPU 14 functions as the I/O data movement control unit 11 by executing the I/O data movement control program 1621. Further, the CPU 14 functions as the optimal bridge search unit 12 by executing the optimal bridge search program 1622. Further, the CPU 14 functions as the I/O device driver unit a 13a by executing the I/O device driver program a 1623a. Further, the CPU 14 functions as the I/O device driver unit b 13b by executing the I/O device driver program b 1623b.

The bus bridge 15 is a device which relays data transmitted or received among the CPU 14, the main memory 16, and the network bridge A 2A.

The network bridge A 2A includes a control unit A 21A and a bridge memory A 22A, and transfers, via the network 3, data transmitted or received between the CPU 14 or the main memory 16 and the I/O device a 4a or the I/O device b 4b.

The control unit A 21A has a function of inputting or outputting data to or from the bus bridge 15, for example, according to a predetermined protocol such as PCIe or PCI. Further, the bridge memory A 22A is managed by the control unit A 21A and is used to temporarily hold data transferred by the control unit A 21A and to relay data transfer.

This control unit A 21A has a function of performing encapsulation by adding predetermined header information or the like to a packet generated according to the predetermined protocol such as PCIe or PCI and converting the resultant packet into a packet of a predetermined protocol used in the network 3. Further, the control unit A 21A has a function of performing decapsulation by removing predetermined control information from the packet generated according to the predetermined protocol used in the network 3 and converting the resultant packet into the packet of the predetermined protocol such as PCIe or PCI. Further, the control unit A 21A has a function of controlling transfer of data by DMA (Direct Memory Access) through the bridge memory A 22A between the main memory 16 and the I/O device a 4a, the I/O device b 4b or the like.

In other words, the control unit A 21A has a function of writing data received from the I/O device a 4a, the I/O device b 4b or the like to the bridge memory A 22A, or reading the data from the bridge memory A 22A, and transmitting the data to the I/O device a 4a, the I/O device b 4b or the like according to a request for a DMA write operation or DMA read received from the I/O device a 4a, the I/O device b 4b or the like. Further, the control unit A 21A has a function of notifying the I/O data movement control unit 11 of completion of the process for a DMA write operation or a DMA read operation in the data transfer to or from the I/O devices such as the I/O device a 4a and the I/O device b 4b.

The network bridge a 2a includes a control unit a 21a and a bridge memory a 22a, and transfers, via the network 3, data transmitted or received between the I/O device a 4a and the CPU 14 or the main memory 16 or between the I/O device a 4a and the I/O device b 4b.

The control unit a 21a has a function of inputting or outputting data from or to the I/O device a 4a, for example, according to a predetermined protocol such as PCIe or PCI. Further, the bridge memory a 22a is managed by the control unit a 21a and used to temporarily hold data transferred by the control unit A 21A and to relay data transfer.

This control unit a 21a has a function of performing encapsulation by adding predetermined header information or the like to a packet generated according to a predetermined protocol such as PCIe or PCI and converting the resultant packet into a packet of the predetermined protocol used in the network 3. Further, the control unit a 21a has a function of performing decapsulation by removing predetermined control information from the packet generated according to the predetermined protocol used in the network 3, and converting the resultant packet into the packet of the predetermined protocol such as PCIe or PCI. Furthermore, the control unit a 21a has a function of controlling transfer of data by DMA through the bridge memory a 22a between the computer 1 or the main memory 16 and the I/O device a 4a, the I/O device b 4b or the like.

In other words, the control unit a 21a has a function of writing data received from the computer 1, the I/O device a 4a, the I/O device b 4b or the like to the bridge memory a 22a or reading data from the bridge memory a 22a and transmitting the data to the computer 1, the I/O device a 4a, the I/O device b 4b or the like according to a request of a DMA write operation or DMA read operation received from the computer 1, the I/O device a 4a, the I/O device b 4b or the like. Further, the control unit a 21a has a function of notifying the I/O data movement control unit 11 of completion of the process for a DMA write operation or a DMA read operation in the data transfer to or from I/O devices such as the I/O device a 4a and the I/O device b 4b.

The network bridge b 2b includes a control unit b 21b and a bridge memory b 22b, and transfers, via the network 3, data transmitted or received between the I/O device b 4b and the CPU 14 or the main memory 16 or between the I/O device b 4b and the I/O device a 4a.

The control unit b 21b has a function of inputting or outputting data from or to the I/O device b 4b, for example, according to the predetermined protocol such as PCIe or PCI. Further, the bridge memory b 22b is managed by the control unit b 21b and used to temporarily hold and relay data transferred by the control unit b 21b.

This control unit b 21b has a function of performing encapsulation by adding predetermined header information or the like to a packet generated according to the predetermined protocol such as PCIe or PCI, and converting the packet into a packet of the predetermined protocol used in the network 3. Further, the control unit b 21b has a function of performing decapsulation by removing predetermined control information from a packet generated according to the predetermined protocol used in the network 3, and converting the packet into the packet of the predetermined protocol such as PCIe or PCI. Further, the control unit b 21b has a function of controlling the transfer of data by DMA through the bridge memory b 22b between the computer 1 or the main memory 16 and the I/O device a 4a, the I/O device b 4b or the like.

In other words, the control unit b 21b has a function of writing data received from the computer 1, the I/O device a 4a, the I/O device b 4b or the like to the bridge memory b 22b or reading data from the bridge memory b 22b or the like and transmitting the data to the computer 1, the I/O device a 4a, the I/O device b 4b or the like according to a request of a DMA write operation or a DMA read operation received from the computer 1, the I/O device a 4a, the I/O device b 4b or the like. Further, the control unit b 21b has a function of notifying the I/O data movement control unit 11 of completion of the process for a DMA write operation or a DMA read operation in data transfer to or from I/O devices such as the I/O device a 4a and the I/O device b 4b.

Further, storage capacities of the bridge memory A 22A, the bridge memory a 22a and the bridge memory b 22b may be different from one another. For example, maximum payload lengths of packets (i.e., sizes of storage areas of main bodies of data except for control information such as header information in the packets) to be transferred may be different from one another.

As described above, the network bridge A 2A allows the computer 1 to use the I/O device a 4a and the I/O device b 4b by transmitting communication of PCIe or PCI with the network bridge a 2a and the network bridge b 2b. Further, the network bridge a 2a and the network bridge b 2b, for example, allow the I/O device a 4a and the I/O device b 4b to directly move data through DMA by transmitting communication of PCIe or PCI between the I/O device a 4a and the I/O device b 4b. In this case, the network bridge A 2A typically encapsulates a packet of PCIe or the like into the packet of the network 3 and transmits the resultant packet between the network bridge a 2a and the network bridge b 2b.

The I/O device driver unit a 13a issues a command to perform writing or reading of data to or from the I/O device a 4a by the CPU 14 executing the I/O device driver program a 1623a. Further, the I/O device driver unit b 13b issues a command to perform writing or reading of data to or from the I/O device b 4b by the CPU 14 executing the I/O device driver program b 1623b.

The I/O data movement control unit 11 controls data movement from the I/O device a 4a to the I/O device b 4b and data movement from the I/O device b 4b to the I/O device a 4a by the CPU 14 executing the I/O data movement control program 1621. In this case, the I/O data movement control unit 11 instructs the optimal bridge search unit 12 to determine which of the network bridge A 2A, the network bridge a 2a and the network bridge b 2b as a network bridge holding a bridge memory optimal as a relay memory for data movement (in this case, any one of the bridge memory A 22A, the bridge memory a 22a and the bridge memory b 22b) is a memory used for data movement.

For example, when data is moved from the I/O device a 4a to the I/O device b 4b, the I/O data movement control unit 11 first receives information of the network bridge holding the optimal bridge memory selected as will be described below by the optimal bridge search unit 12. Further, a priority or a condition for determination of optimality is assumed to be set in advance.

Also, the I/O data movement control unit 11 causes the I/O device a 4a to write data moved from the I/O device a 4a to the bridge memory (in this case, any one of the bridge memory A 22A, the bridge memory a 22a and the bridge memory b 22b) held by the optimal network bridge determined by the optimal bridge search unit 12 through DMA by calling the I/O device driver unit a 13a. Further, the I/O data movement control unit 11 calls the I/O device driver unit b 13b and causes the I/O device b 4b to read the data (in this case, the data written through DMA by the I/O device a 4a) from the bridge memory through DMA.

In this case, when viewed from the I/O data movement control unit 11, the I/O data movement control unit 11 can simultaneously perform a plurality of processes (e.g., a plurality of sets of data transfer processes in each division range obtained by dividing a transfer target address range in plurality) in each process of reading the data from the I/O device a 4a to the bridge memory and writing the data from the bridge memory to the I/O device b 4b. In other words, the I/O data movement control unit 11 can maximize a band of the data movement between the I/O devices by performing a plurality of data movement processes at the same time. Here, the reading of the data to the bridge memory when viewed from the I/O data movement control unit 11 is a process performed by a DMA write operation of the I/O device a 4a, and the writing of the data to the I/O device b13b is a process performed by a DMA read operation of the I/O device b 4b.

Further, when data is moved from the I/O device b 4b to the I/O device a 4a in contrast to the above-described example, and if the I/O data movement control unit 11 receives information of the network bridge holding the optimal bridge memory from optimal bridge search unit 12, the I/O data movement control unit 11 causes the I/O device b 4b to write the data moved from the I/O device b 4b to the bridge memory (in this case, any one of the bridge memory A 22A, the bridge memory a 22a and the bridge memory b 22b) held by the optimal network bridge through DMA by calling the I/O device driver unit b 13b. Further, the I/O data movement control unit 11 calls the I/O device driver unit a 13a and causes the I/O device a 4a to read the data (in this case, the data written through DMA by the I/O device b 4b) from the bridge memory through DMA.

Next, the bridge information 161 is illustrated in FIG. 2. The bridge information 161 includes information associating the network bridge A 2A, the network bridge a 2a and the network bridge b 2b with the I/O device a 4a and the I/O device b 4b to which the network bridge a 2a and the network bridge b 2b are connected. Further, the bridge information 161 holds a maximum packet payload length available for reading and writing processes from and to the bridge memory A 22A, the bridge memory a 22a and the bridge memory b 22b held by the network bridge A 2A, the network bridge a 2a and the network bridge b 2b. Generally, memory access efficiency is high when the maximum payload length is greater.

Here, the information of the bridges managed by the bridge information 161 need not include all three of a bridge name, information indicating a connection I/O device, and information indicating the maximum payload length, as illustrated in FIG. 2. In the example illustrated in FIG. 2, the bridge information 161 includes, for example, information for the network bridge n in addition to information for the network bridge A2A, the network bridge a2a and the network bridge b2b.

Next, the parallel process management table 163 is illustrated in FIG. 3. The parallel process management table 163 holds a movement source I/O device, a movement destination I/O device, a data length of moving data, a data length of data already moved during the movement process, a flag indicating the presence or absence of movement process completion, an address of data moved from the movement source I/O device, and information indicating an address to which the data is written in the movement destination I/O device in association with one another in each of data movement processes executed in parallel. For example, when data is moved from the I/O device a 4a to the I/O device b 4b, the parallel process management table 163 holds information indicating the I/O device a 4a serving as a movement source, the I/O device b 4b serving as a movement destination, a data length of moving data, a data length of data which is already moved, a flag indicating movement process completion, a top address in the I/O device a 4a of data moved from the I/O device a 4a, and a top address in the I/O device b 4b to which data is written in the I/O device b 4b. These addresses are expressed using addresses mapped with a memory space 5 accessible to the computer 1, which will be described next. Further, this memory space 5 includes a memory provided outside the computer 1.

Next, the memory space 5 of the computer 1 is illustrated in FIG. 4. In the I/O device control system 10 of FIG. 1, the network bridge A 2A, the network bridge a 2a and the network bridge b 2b are mapped to the memory space 5, i.e., a storage area to which addresses accessible to the CPU 14 are assigned, as illustrated in FIG. 4. Here, the bridge memory A 22A, the bridge memory a 22a and the bridge memory b 22b are mapped to storage areas to which the network bridge A 2A, the network bridge a 2a and the network bridge b 2b are assigned in the memory space 5.

Therefore, the I/O device a 4a or the I/O device b 4b can access the bridge memory A 22A, the bridge memory a 22a and the bridge memory b 22b by accessing predetermined addresses of the memory space 5 of the computer Ito which the bridge memory A 22A, the bridge memory a 22a and the bridge memory b 22b are mapped. Therefore, when the I/O device a 4a or the I/O device b 4b has an interface conforming to PCIe or PCI, the I/O device a 4a or the I/O device b 4b can access the bridge memory A 22A, the bridge memory a 22a and the bridge memory b 22b according to a procedure conforming to PCIe or PCI without a special change on software or hardware by setting reading or writing target addresses to addresses corresponding to the bridge memory A 22A, the bridge memory a 22a and the bridge memory b 22b on the program.

As described above, the I/O device a 4a can perform reading and writing of data from and to the bridge memory A 22A, the bridge memory a 22a and the bridge memory b 22b respectively held by the network bridge A 2A, the network bridge a 2a and the network bridge b 2b by accessing the address areas of the network bridge of a memory map as illustrated in FIG. 4. Similarly, the I/O device b 4b can perform reading and writing of data from and to the bridge memory A 22A, the bridge memory a 22a and the bridge memory b 22b respectively held by the network bridge A 2A, the network bridge a 2a and the network bridge b 2b by accessing the address areas of the network bridge of the memory map as illustrated in FIG. 4.

Further, in the example illustrated in FIG. 4, an address of the network bridge n is assigned to the memory space 5 in addition to the three network bridge of the network bridge A 2A, the network bridge a 2a and the network bridge b 2b.

Next, the optimal bridge search unit 12 selects a bridge memory suitable to be used when data is moved between I/O devices by the CPU 14 executing the optimal bridge search program 1622. The optimal bridge search unit 12 selects, for example, the network bridge holding the bridge memory which is optimal (i.e., capable of performing data transfer more effectively) as a relay memory for moving data from the I/O device a 4a to the I/O device b 4b by referring to the bridge information 161.

In this embodiment, in PCIe used as an interface of the I/O device a 4a, the I/O device b 4b or the like, the DMA write operation is posted type access which does not wait for a notice of completion.

On the other hand, the DMA read operation is a non-posted type access in which arrival of read data is a completion notice, and it is necessary to wait for the completion of a previous request in order to issue a next request. Therefore, the DMA read operation is greatly influenced by latency of performance (i.e., a delay time between request responses) in comparison with the DMA write operation.

Therefore, it is possible to improve efficiency of the data movement between the I/O devices if the bridge memory can be selected so that the influence of the latency of the DMA read operation is reduced.

Therefore, the optimal bridge search unit 12 selects the bridge memory in such a manner that a data transfer time between the I/O device on the side performing a DMA read operation and the bridge memory becomes shorter than a data transfer time between the I/O device on the side performing a DMA write operation and the bridge memory to reduce the influence of this latency.

In this embodiment, for example, when the data is moved from the I/O device a 4a to the I/O device b 4b, the I/O device a 4a writes data to the relay memory (i.e., the bridge memory) using DMA, and the I/O device b 4b reads the data from the relay memory (i.e., the bridge memory) using DMA. Therefore, in this case, the latency of the DMA read operation can be reduced by selecting the bridge memory whose data transfer time with respect to the I/O device b 4b serving as a data movement destination is shortest (i.e., whose distance is small) using the optimal bridge search unit 12. In other words, the optimal bridge search unit 12 searches for the network bridge holding the bridge memory nearest to the data movement destination by referring to the bridge information 161 and, in this case, selects the network bridge b 2b connected to the I/O device b 4b which is a data movement destination as the optimal bridge.

Further, the selection of the network bridge by the optimal bridge search unit 12 is not limited to the above scheme and, for example, the optimal bridge search unit 12 may search for a maximum payload length of each bridge held in the bridge information 161 and select a bridge holding the maximum payload length as the bridge holding the optimal network memory, instead of selecting the optimal bridge using the distance from the I/O device b 4b.

Further, a condition of selection of the optimal bridge is set in advance, and the optimal bridge search unit 12 selects the optimal bridge from among bridge memories relaying the movement of the data between the I/O devices based on this set condition. For example, when it is determined that the bridge memory nearest to the data movement destination I/O device is selected as the optimal bridge, a bridge memory nearest to the data movement destination I/O device among a plurality of bridge memories is determined as a memory to which the data movement source I/O device writes data or a memory unit from which the data movement destination I/O device reads the data. Similarly, for example, when it is determined that a bridge memory whose payload length of a packet on which data reading and writing are performed is greatest is selected as the optimal bridge, a bridge memory whose payload length of the packet on which data reading and writing are performed is greatest among the plurality of bridge memories is determined as a memory to which the data movement source I/O device writes data or as a memory unit from which the data movement destination I/O device reads the data. Further, for example, when it is determined that a bridge memory optimal for movement of data is selected as the optimal bridge in consideration of both the distance from the I/O device serving as a movement destination and the payload length, a bridge memory determined to be a bridge memory optimal for movement of data based on both the distance from the I/O device serving as a movement destination and the payload length among the plurality of bridge memories is determined as the memory to which the data movement source I/O device writes data or the memory unit from which the data movement destination I/O device reads the data.

Further, for the selection of the optimal network bridge, a bridge evaluated to be highest in an evaluation expression including factors of the distance from the movement destination I/O device b 4b and the maximum payload length in consideration of both the distance from the movement destination I/O device b 4b and the maximum payload length may also be selected as a bridge holding the optimal network memory.

In other words, when there are a plurality of candidates for the bridge memory relaying the movement of the data between the I/O devices, the optimal bridge search unit 12 selects a bridge memory nearest to the data movement destination I/O device, a bridge memory whose payload length of the packet on which data reading and writing is performed is greatest, or a bridge memory optimal for the movement of data in consideration of both the distance from the movement destination I/O device and the payload length.

Next, an operation of the present embodiment will be described with reference to the block diagram of FIG. 1 and a flowchart of FIG. 5. Further, the operation example illustrated in FIG. 5 shows a case in which data is moved from the I/O device a 4a to the I/O device b 4b. Further, an interface of the I/O device a 4a and the I/O device b 4b is assumed to be PCIe.

Here, it is assumed that a predetermined application program executed in the CPU 14 calls the I/O data movement control unit 11 and instructs data movement from the I/O device a 4a to the I/O device b 4b. In this case, first, the I/O data movement control unit 11 inquires the optimal bridge search unit 12 of a network bridge holding an optimal bridge memory relaying the data movement from the I/O device a 4a to the I/O device b 4b (step A1). Here, a case in which the optimal bridge search unit 12 determines a network bridge nearest to the I/O device b 4b to be the optimal bridge is considered.

In this case, the optimal bridge search unit 12 determines the network bridge b 2b connected with the I/O device b 4b to be the optimal bridge by referring to the bridge information 161, and sends the fact to the I/O data movement control unit 11 (step A2).

Then, the I/O data movement control unit 11 calls the I/O device driver unit a 13a to cause the I/O device a 4a to write the data to the bridge memory b 22b through DMA (step A3).

When the data is written to the bridge memory b 22b, the I/O data movement control unit 11 is called by the control unit b 21b. The I/O data movement control unit 11 then calls the I/O device driver unit b 13b to cause the I/O device b 4b to read the data of the bridge memory b 22b through DMA (step A4).

When the reading of the data is completed, the I/O data movement control unit 11 is called by the control unit b 21b again.

When an amount of data moved from the I/O device a 4a to the I/O device b 4b reaches a scheduled capacity or corresponds to another end condition, the I/O data movement control unit 11 completes the data movement process (Yes in step A5).

Further, when the data amount does not correspond to the end condition, the I/O data movement control unit 11 repeats the process of steps A3 and A4 (No in step A5).

Thus, the I/O data movement control unit 11 repeatedly executes the process of the writing of the data to the bridge memory by the data movement source I/O device and the reading of the data from the bridge memory by the data movement destination I/O device until the movement of the scheduled data amount is completed. In other words, the I/O data movement control unit 11 instructs control of writing for the data movement source I/O device and instructs control of reading from the data movement destination I/O device until the movement of the data for this data amount is completed based on “information indicating a data amount of moving data” acquired when executing the application program.

Here, in the process of step A3, when the I/O device a 4a is a device starting a DMA process using the command issued by the I/O device unit a 13a as a trigger, for example, like a storage device, it is necessary for the I/O data movement control unit 11 to call the I/O device unit a 13a in each process of step A3.

On the other hand, when the I/O device a 4a is a device starting the DMA process using data input from the outside as a trigger, for example, as can be seen in a network device, it is not necessary for the I/O data movement control unit 11 to call the I/O device unit a 13a in each process of step A3.

Next, operations when data movements are performed in parallel will be described with reference to FIGS. 6 and 7. An operation example illustrated in FIGS. 6 and 7 shows a case in which a plurality of sets of processes of moving data from the I/O device a 4a to the I/O device b 4b are executed in parallel. In other words, in the operation example illustrated in FIGS. 6 and 7, a plurality of sets of data movements between the data movement source I/O device and the data movement destination I/O device are performed in parallel. Further, the interface of the I/O device a 4a and the I/O device b 4b is assumed to be PCIe. Further, processes corresponding to the processes illustrated in FIG. 5 are denoted with the same reference signs.

Referring to FIG. 6, the operation of performing the data movement in parallel is different from that in FIG. 5 in that steps B1 and B2 are included in place of steps A3 to A5. In step B1, the I/O data movement control unit 11 sets information on an address and a data length of data to be moved in the parallel process management table 163 (step B1).

A setting example of the parallel process management table 163 is illustrated in FIG. 8. In the example illustrated in FIG. 8, two processes of moving data from the I/O device a 4a to the I/O device b 4b are set in the parallel process management table 163. Two transfer processes, including one in which an address of data moved from the movement source I/O device a 4a is “a1” and an address to which data is written in the movement destination I/O device b 4b is “b1,” and another in which an address of data moved from the movement source I/O device a 4a is “a2” and an address to which data is written in the movement destination I/O device b 4b is “b2,” are set in the parallel process management table 163 of FIG. 8.

Then, the I/O data movement control unit 11 starts two or more processes (i.e., n processes) of moving data from the I/O device a 4a to the I/O device b 4b in parallel (step B2).

FIG. 7 is a flowchart illustrating one data movement process from the I/O device a 4a to the I/O device b 4b executed in parallel (i.e., for example, in time division). First, the I/O data movement control unit 11 sets predetermined information used for transfer of data in the I/O device driver unit a 13a by referring to the parallel process management table 163.

Then, the I/O data movement control unit 11 instructs the I/O device unit a 13a to issue a predetermined command to the I/O device a 4a. Here, the I/O device unit a 13a causes the I/O device a 4a to write data to the bridge memory b 22b through DMA (step B3).

Then, the I/O device driver unit b 13b is called by the I/O data movement control unit 11, and the I/O device driver unit b 13b causes the I/O device b 4b to read the data from the bridge memory b 22b through DMA (step B4). Then, the I/O data movement control unit 11 updates the parallel process management table 163 using the information of the data movement completed in the data movement process (step B5).

Here, when the moved data recorded on the parallel process management table reaches a scheduled movement data amount or when a movement process end flag of the parallel process management table 163 is asserted, the data movement process ends.

On the other hand, when the data does not reach the movement data amount or when the movement process end flag is not asserted, the I/O data movement control unit 11 repeats the process from step B3 (step B6).

While the case in which the number of I/O devices is 2 has been shown in this embodiment, the number of the I/O devices is not limited thereto, and a system holding any number of devices can be realized. In this case, any of the plurality of I/O devices may be selected as the data movement source I/O device and the data movement destination I/O device.

Further, while the memory held by the network bridge has been shown as the memory relaying the data movement between the I/O devices in the present embodiment, it is not necessary for the network bridge and the relay memory to be integrally mounted, and a configuration in which the relay memory is realized as a separate element and the realized memory is connected to the network and used may be adopted. FIG. 9 is a block diagram illustrating an I/O device control system 10a as another embodiment according to the present invention in which a network bridge c 2c is added to the I/O device control system 10 of FIG. 1.

The network bridge c 2c of FIG. 9 has the same configuration as the network bridge a 2a or the network bridge b 2b, and includes a control unit c 21c corresponding to the control unit a 21a or the control unit b 21b, and a bridge memory c 22c corresponding to the bridge memory a 22a or the bridge memory b 22b.

However, an I/O device is not directly connected to the network bridge c 2c. The bridge memory c 22c may be used as a relay memory at the time of data movement between I/O devices by an I/O device a 4a or an I/O device b 4b, as in the configuration of FIG. 1.

Next, effects of the embodiments shown above will be described. In the above embodiments, the data movement between the two or more I/O devices connected via the network is performed via the bridge memory held by the network bridge. Accordingly, it is not necessary for the moving data to pass through a main memory or a bus bridge of the computer, and it is possible to perform the data movement between the I/O devices at a high speed without limiting a band of the main memory or the bus bridge. Further, since the moving data does not pass through the main memory or the bus bridge, it is possible to perform the data movement between the I/O devices without affecting performance of other application programs using the main memory or the bus bridge.

Further, the present invention is applicable to moving of data between I/O devices at a high speed in a computing system, a network system, a storage system, an embedded system, or a special apparatus. Further, the present invention is applicable to performance of the data movement between the I/O devices without consuming CPU, memory bus or I/O bus resources in these systems.

Further, the embodiments of the present invention are not limited to the foregoing and, for example, modifications or the like may be appropriately performed, including allowing a plurality of I/O devices to be connected to one network bridge or providing a plurality of bridge memories in one network bridge. Further, the I/O data movement control unit 11 of FIG. 1, for example, may be executed by a CPU, which is not illustrated, other than the CPU 14 in the computer 1, or executed by a CPU, which is not illustrated, outside the computer 1.

Further, a block diagram of a basic configuration of an embodiment of the present invention including each embodiment of the present invention illustrated in FIGS. 1 and 9 is illustrated in FIG. 10. In the basic configuration of the embodiment of the present invention, an I/O device control system 10b includes a plurality of bridge units 105, 106, and 107 which connect a computer 101, a data movement source I/O device 102 from which data is moved, and a data movement destination I/O device 103 to which the data is moved, to a network 104, a memory unit 108 which relays the movement of data between the data movement source I/O device 102 and the data movement destination I/O device 103 in the outside of the computer 101, and an I/O data movement control unit 109 which causes the data movement source I/O device 102 to write data to the memory unit 108 and causes the data movement destination I/O device 103 to read the data from memory unit 108, as illustrated in FIG. 10.

Here, the memory unit 108 may be mounted inside the bridge unit 105 to 107, or may be provided outside the bridge unit 105 to 107, for example, by being connected to the network 3 via a relay unit different from the bridge unit 105 to 107.

Correspondence between the components of the I/O device control system 10b of FIG. 10 and the components of the I/O device control system 10 illustrated in FIG. 1 is as follows. The computer 101 corresponds to the computer 1 of FIG. 1. The data movement source I/O device 102 and the data movement destination I/O device 103 correspond to the I/O device a 4a and the I/O device b 4b. The network 104 corresponds to the network 3. The bridge unit 105 to 107 correspond to the network bridge A 2A, the network bridge a 2a and the network bridge b 2b. The memory unit 108 corresponds to the bridge memory A 22A, the bridge memory a 22a, the bridge memory b 22b and the bridge memory c 22c. Also, the I/O data movement control unit 109 corresponds to the I/O data movement control unit 11.

Priority is claimed on Japanese Patent Application No. 2011-237593, filed Oct. 28, 2011, the content of which is incorporated herein by reference.

### INDUSTRIAL APPLICABILITY

According to the I/O device control system in accordance with the present invention, when data is moved between I/O devices, it is possible to provide the I/O device control system capable of effectively performing the data movement.

### DESCRIPTION OF REFERENCE SYMBOLS

1 computer
2 A network bridge A
2a network bridge a
2b network bridge b
2c network bridge c
3 network
4a I/O device a
4b I/O device b
5 memory space
10 I/O device control system
10a I/O device control system
11 I/O data movement control unit
12 optimal bridge search unit
13a I/O device driver unit a
13b I/O device driver unit b
14 CPU
15 bus bridge
16 main memory
17 CPU
22A bridge memory A
22a bridge memory a
22b bridge memory b
   102 data movement source I/O device
100 I/O device control system
101 computer
103 data movement destination I/O device
104 network
105-107 bridge unit
108 memory unit
109 I/O data movement control unit
161 bridge information
162 computer program
163 parallel process management table
1621 I/O data movement control program
1622 optimal bridge search program
1623a I/O device driver program a
1623b I/O device driver program b

1. An I/O device control system comprising:
a plurality of bridge units configured to connect a data movement source I/O device from which data is moved, a data movement destination I/O device to which the data is moved, and a computer which controls the movement of the data to a network;
a memory unit provided outside the computer which holds the data moving between the data movement source I/O device and the data movement destination I/O device; and
an I/O data movement control unit provided inside the computer which instructs the data movement source I/O device to perform control of writing the data to the memory unit, and instructs the data movement destination I/O device to perform control of reading the data from the memory unit.

2. The I/O device control system according to claim 1,
wherein the memory unit is mounted on the bridge unit, and
the data movement source I/O device and the data movement destination I/O device access the memory unit using an address of the bridge unit mapped in a memory space accessible to the computer.

3. The I/O device control system according to claim 1,
wherein there are a plurality of candidates for the memory unit which relays the movement of the data between the data movement source I/O device and the data movement destination I/O device, and
the I/O device control system further includes an optimal memory selection unit which determines, as the memory unit to which the data movement source I/O device writes the data or the memory unit from which the data movement destination I/O device reads the data, any one of a first memory unit nearest to the data movement destination I/O device, a second memory unit which holds data whose payload length of a packet on which reading control or writing control for the data is performed is greatest, and a third memory unit determined to be optimal for the movement of the data based on both a distance from the data movement destination I/O device and the payload length among the plurality of memory units.

4. The I/O device control system according to claims 1,
wherein a process of the control of writing data to the memory unit by the data movement source I/O device and the control of reading data from the memory unit by the data movement destination I/O device is repeated until movement of an amount of data scheduled to be moved is completed.

5. The I/O device control system according to claim 1,
wherein a plurality of processes of data movement between the data movement source I/O device and the data movement destination I/O device are performed in parallel.

6. A method for controlling an I/O device comprising:
connecting a data movement source I/O device which is a data movement source, a data movement destination I/O device which is a data movement destination, and a computer which controls movement of the data to a network by a plurality of bridge units; and
instructing the data movement source I/O device to perform control of writing the data to a memory unit provided outside the computer, and instructing the data movement destination I/O device to perform control of reading the data from the memory unit.

7. The method for controlling an I/O device according to claim 6, comprising instructing to access the memory unit using an address of the bridge unit mapped in a memory space accessible to the computer when instructing the writing control and the reading control.

8. The method for controlling an I/O device according to claim 6, comprising determining, as the memory unit to which the data movement source I/O device writes the data or the memory unit from which the data movement destination I/O device reads the data when instructing the writing control and the reading control, any one of a first memory unit nearest to the data movement destination I/O device, a second memory unit which holds data whose payload length of a packet on which reading control or writing control for the data is performed is greatest, and a third memory unit determined to be optimal for the movement of the data based on both a distance from the data movement destination I/O device and the payload length among the plurality of memory units provided between the data movement source I/O device and the data movement destination I/O device.

9. The method for controlling an I/O device according to claim 6, comprising repeating a process of the control of writing data to the memory unit by the data movement source I/O device and the control of reading data from the memory unit by the data movement destination I/O device until movement of an amount of data scheduled to be moved is completed.

10. The method for controlling an I/O device according to claim 6, comprising performing a plurality of processes of data movement between the data movement source I/O device and the data movement destination I/O device in parallel.
